(19) United States
(12) Patent Application Publication
(10) Pub. No.: US 2025/0199850 A1
(43) Pub. Date: Jun. 19, 2025

(54) THROTTLING KERNEL SCHEDULING TO MINIMIZE CACHE CONTENTION

(71) Applicant: Advanced Micro Devices, Inc., Santa Clara, CA (US)

(72) Inventors: Vinay Bharadwaj Ramakrishnaiah, Redmond, VA (US); Bradford Michael Beckmann, Kirkland, WA (US); William Peter Ehrett, Austin, TX (US)

(21) Appl. No.: 18/540,663

(22) Filed: Dec. 14, 2023

(51) Int. Cl. G06F 9/48

(52) U.S. Cl. CPC G06F 9/4881

(57) ABSTRACT

An apparatus and method for efficiently scheduling kernels for execution in a computing system. In various implementations, a computing system includes a cache and a processing circuit with multiple compute circuits and a scheduler. The scheduler groups kernels into scheduling groups where each scheduling group includes particular kernels of the multiple kernels that access a same data set different from a data set of another scheduling group. Each of these scheduling groups is referred to as a “cohort.” The scheduler accesses completion time estimates of kernels of the cohorts. Using the completion time estimates, the number of kernels currently executing, and the number of remaining kernels that have not yet begun execution of each currently scheduled cohort, the scheduler determines whether to immediately schedule a next cohort or delay scheduling the next cohort. By doing so, the scheduler balances throughput and cache contention.

### BACKGROUND

### Description of the Relevant Art

Highly parallel data applications are used in a variety of fields such as science, entertainment, finance, medical, engineering, social media, and so on. Machine learning data models process large amounts of data by performing complex calculations at substantially high speeds. With an increased number of processing circuits in computing systems, the latency to deliver data to the processing circuits becomes emphasized. The performance, such as throughput, of the processing circuits depends on quick access to stored data.

The available data bandwidth for lower levels of the memory hierarchy of the computing system is relatively high. However, the achieved bandwidth becomes limited due to the lower response bandwidth. Therefore, when techniques are used to saturate the available bandwidth for accessing the lower levels of the memory hierarchy, the overall bandwidth is still limited since these techniques do not handle any inefficiencies in the response bandwidth.

In view of the above, efficient methods and mechanisms for efficiently scheduling kernels for execution on an integrated circuit are desired.

### BRIEF DESCRIPTION OF THE DRAWINGS

FIG. 1 is a generalized block diagram of a computing system that efficiently schedules kernels for execution on an integrated circuit.

FIG. 2 is a generalized block diagram of a command storage arrangement that supports efficient scheduling of kernels for execution on an integrated circuit.

FIG. 3 is a generalized block diagram of an apparatus that efficiently schedules kernels for execution on an integrated circuit.

FIG. 4 is a generalized block diagram of an apparatus that efficiently schedules kernels for execution on an integrated circuit.

FIG. 5 is a generalized block diagram of a data storage arrangement that occurs during efficient scheduling of kernels for execution on an integrated circuit.

FIG. 6 is a generalized block diagram of a data storage arrangement that occurs during efficient scheduling of kernels for execution on an integrated circuit.

FIG. 7 is a generalized block diagram of a method for efficiently scheduling kernels for execution on an integrated circuit.

FIG. 8 is a generalized block diagram of a method for efficiently scheduling kernels for execution on an integrated circuit.

FIG. 9 is a generalized block diagram of a method for efficiently scheduling kernels for execution on an integrated circuit.

FIG. 10 is a generalized block diagram of a method for efficiently scheduling kernels for execution on an integrated circuit.

FIG. 11 is a generalized block diagram of a computing system that efficiently schedules kernels for execution on an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods that efficiently schedule kernels for execution on an integrated circuit are contemplated. In various implementations, a computing system includes a cache and a processing circuit with multiple compute circuits and a scheduler. In some implementations, the processing circuit is a parallel data processing circuit with a single-instruction-multiple-data (“SIMD”) microarchitecture. Each of the multiple compute circuits includes one or more SIMD circuits, each with circuitry of multiple lanes of simultaneous execution. In an implementation, the cache represents a last level shared cache structure such as a level-two (L2) cache within a partition of the processing circuit. Each partition includes multiple compute circuits and a last level shared cache structure. In an implementation, the processing circuit is a graphics processing unit (GPU) with a command processing circuit, which is also referred to as a “command processor.” The command processing circuit includes the scheduler. Multiple processes of a highly parallel data application provide multiple kernels to be executed on the multiple compute circuits.

Each kernel corresponds to a function call of the highly parallel data application. Each kernel includes multiple wavefronts, and the scheduler groups kernels into scheduling groups where each scheduling group includes particular kernels of the multiple kernels of the highly parallel data application that access a same data set different from a data set of another scheduling group. In an implementation, the data set is an input working data set. As used herein, each of the terms “cohort” and “cache cohort” refer to a scheduling group that includes kernels that access a same data set different from a data set of another scheduling group. As used herein, the data set of a cohort is referred to as “cohort data.” These kernels of the cohort can be from different operations in the highly parallel data application. In an implementation, the user defines the cohorts by marking cohort boundaries with particular instructions in the highly parallel data application.

Rather than schedule the kernels for dispatch and execution as soon as hardware resources of the multiple compute circuits are available to increase throughput, the scheduler instead, at times, delays scheduling of multiple kernels of some cohorts to minimize cache contention in the last level shared cache structure of a partition. The scheduler attempts to balance high throughput and low cache contention. When kernels of a particular cohort are scheduled for dispatch and execution and begin executing on the multiple compute circuits, the cohort data is retained in the cache, which maximizes cache hits for memory requests generated by the cohorts targeting the cohort data. Data for the currently executing cohorts can be capacity-evicted if a compute circuit begins executing a kernel of a new cohort and the cohort data of the currently executing cohorts occupy the entire cache. As used herein, the term “dispatch” refers to wavefronts being selected and sent from a dispatch circuit to compute circuits for execution. As used herein, the term “issue” refers to instructions of a wavefront within a compute circuit being selected and sent to the multiple lanes of execution of one of the multiple SIMD circuits of the compute circuit.

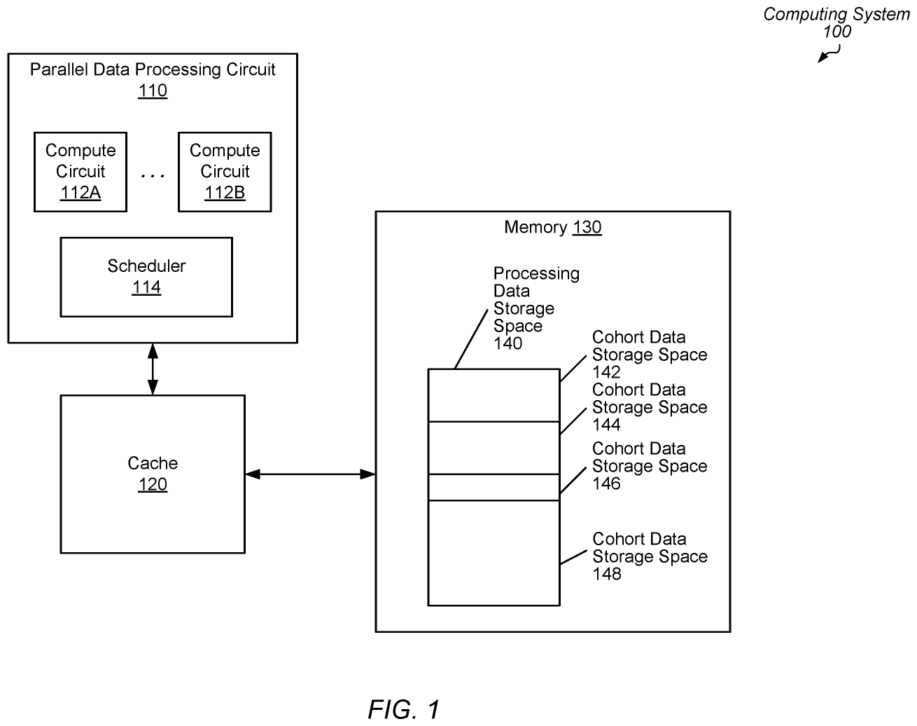

The scheduler accesses completion time estimates of kernels of the cohorts. These completion time estimates include both completion times estimated to be achieved when a corresponding data set is stored in the cache and completion times estimated to be achieved when a corresponding data set is not stored in the cache. Using the completion time estimates, the number of kernels currently executing, and the number of remaining kernels that have not yet begun execution of each currently scheduled cohort, the scheduler determines whether to immediately schedule a next cohort or delay scheduling the next cohort. For example, when there are a relatively few remaining available SIMD circuits on which to assign wavefronts, the scheduler delays scheduling the next cohort for execution, which reduces cache contention. However, if the scheduler determines that the next cohort has one or more long running kernels, the scheduler immediately schedules the next cohort for execution and launches kernels of the next cohort on the multiple compute circuits, which increases occupancy of the cache occupancy and the number of assigned SIMD circuits. Further details of these techniques to efficiently schedule kernels for execution on an integrated circuit are provided in the following description of FIGS. 1-11.

Referring to FIG. 1, a generalized block diagram is shown of a computing system 100 that efficiently schedules kernels for execution on an integrated circuit. In the illustrated implementation, the computing system 100 includes a parallel data processing circuit 110, a cache 120, and a memory 130. The cache 120 and the memory 130 are used in a cache memory hierarchy of the computing system 100. The parallel data processing circuit 110 includes hardware, such as circuitry, that processes data. For example, the parallel data processing circuit 110 includes at least the compute circuits 112A-112B. An example of the data to process includes the data stored in the processing data storage space 140 (or storage space 140) of the memory 130. The available data storage capacity of the cache 120 is smaller than the storage space 140.

Clock sources, such as phase lock loops (PLLs), interrupt controllers, power controllers, memory controllers, interfaces for input/output (I/O) devices, and so forth are not shown in FIG. 1 for ease of illustration. It is also noted that the number of components of the computing system 100 and the number of subcomponents for those shown in FIG. 1 can vary from implementation to implementation. There can be more or fewer of each component/subcomponent than the number shown for the computing system 100. In some implementations, the functionality of the computing system 100 is included as components on a single die, such as a single integrated circuit. In other implementations, the functionality of the computing system 100 is included as multiple dies on a system-on-a-chip (SOC). In other implementations, the components are individual dies in a system-in-package (SiP) or a multi-chip module (MCM). In yet other implementations, the multiple components of the computing system 100 are individual dies or chips on a printed circuit board. In various implementations, the computing system 100 is used in a desktop, a portable computer, a mobile device, a server, a peripheral device, or other.

In some implementations, the hardware of the parallel data processing circuit 110 (or processing circuit 110) uses a single-instruction-multiple-data (“SIMD”) microarchitecture that includes the multiple compute circuits 112A-112B. Each of the compute circuits 112A-112B includes one or more SIMD circuits, each with multiple parallel execution lanes. In an implementation, the processing circuit 110 is a graphics processing unit (GPU) on a graphics processing card inserted in a motherboard. In other implementations, the processing circuit 110 is an application specific integrated circuit (ASIC), a field programmable gate array (FPGA), an integrated GPU located alongside a host processor (not shown), such as a central processing unit (CPU), or other.

Multiple processes of a highly parallel data application provide multiple kernels to be executed on the multiple compute circuits 112A-112B. Each kernel corresponds to a function call of the highly parallel data application. A particular combination of the same instruction and a particular data item of multiple data items is referred to as a “work item.” A work item is also referred to as a thread. The multiple work items (or multiple threads) are grouped into “wavefronts.” In some implementations, a wavefront includes instructions of a function call (kernel) of the highly parallel data application that operate on multiple data items concurrently. Each function call (kernel) of the highly parallel data application provides one or more wavefronts.

In an implementation, each of the one or more SIMD circuit of a compute circuit is capable of executing a single wavefront and has 32 lanes of execution. Therefore, a wavefront has a size of 32 threads, and a SIMD circuit can simultaneously execute the 32 threads of a wavefront. The processing circuit 110 includes four partitions (not shown), and each partition includes 16 compute circuits of the compute circuits 112A-112B. Therefore, each of the partitions is capable of simultaneously processing 128 wavefronts (16 compute circuits×8 wavefronts per compute circuit). With four partitions, the processing circuit 110 is capable of simultaneously processing 512 wavefronts (4 partitions×128 wavefronts per partition). A kernel includes one or more 32-thread wavefronts. In other implementations, the sizes of each of the SIMD circuits, the compute circuits 112A-112B, the wavefronts, and the partitions have other values based on design requirements.

The address space of the computing system 100 is divided among multiple memories. In some designs, system memory, such as the memory 130, is implemented with one of a variety of dynamic random-access memories (DRAMs), which includes multiple memory devices, each for servicing memory accesses within a particular address range. When the memory 130 is used as system memory, the memory 130 is filled with instructions and data from main memory (not shown) implemented with one of a variety of non-volatile storage devices such as a hard disk drive (HDD) or a solid-state drive (SSD). In various implementations, the address space includes a virtual address space, which is partitioned into a particular page size with virtual pages mapped to physical memory frames. These virtual-to-physical address mappings are stored in a page table in the system memory.

In some designs, access permissions are stored with corresponding virtual-to-physical address mappings. Any local caches (not shown) of the processing circuit 110, the cache 120, the memory 130 used as system memory, and main memory (not shown) are associated with one or more levels of a memory hierarchy. The memory hierarchy transitions from relatively fast, volatile memory, such as registers on a semiconductor die of the processing circuit 110 and caches either located on the processor die or connected to the processor die, such as cache 120, to non-volatile and relatively slow memory.

In some implementations, the faster, volatile memory is considered to be at the top or at the highest level of the memory hierarchy, whereas the slower, non-volatile memory is considered to be at the bottom or the lowest level of the memory hierarchy. In these implementations, a first level of the memory hierarchy is located closer to the faster, volatile memory of the hierarchy than a second level of the memory hierarchy is considered to be at a “higher” level than the second level. In other implementations, the slower, non-volatile memory is considered to be at the top or at the highest level of the memory hierarchy. Although both ways of describing the memory hierarchy are possible and contemplated, in the following description, the faster, volatile memory is considered to be at the top or at the highest level of the memory hierarchy. Therefore, the higher levels of the memory hierarchy include the faster, volatile memory, such as processor registers and level-one (L1) local caches, while the lower levels of the memory hierarchy include the non-volatile, slower memory such as a hard disk drive (HDD) or a solid-state drive (SSD).

In an implementation, the cache 120 represents a last level shared cache structure such as a level-three (L3) cache. One of the compute circuits 112A-112B generates a memory access request that misses in a corresponding local cache. When the cache memory subsystem of the processing circuit 110 is unable to locate the requested cache line, the processing circuit 110 sends a miss request to the cache 120. The cache 120 services the miss request if the cache 120 is able to locate the requested cache line. If not, the system memory (memory 130) and/or main memory sends a cache fill line with the requested cache line (or cache block) to the cache 120 and local caches of the processing circuit 110 to complete the original memory request generated by one of the compute circuits 112A-112B.

As described earlier, each of the terms “cohort” and “cache cohort” refer to a scheduling group that includes kernels that access a same data set different from a data set of another scheduling group. As used herein, the data set of a cohort is referred to as “cohort data.” In some implementations, a developer creates an application that uses cache tiling optimizations to fit data sets used by multiple operations, such as scheduling groups, within the cache 120. In addition to being referred to as “cohort data,” the data set that is shared by multiple scheduling groups is also referred to as a “cache tile.” The data size of a cache tile is based on the amount of data on which scheduling groups operate at a time. Larger cache tiles can decrease the latency of complex operations such as sharpening filters. Smaller cache tiles can reduce the latency of smaller operations and allow the surrounding operations of the application to proceed sooner. Small visual updates of a video game, concert, or movie scene are examples of these smaller operations.

These kernels of the cohort can be from different operations in a highly parallel data application. The storage space 140 includes the sum of the cohort data storage space 142 (or storage space 142), the cohort data storage space 144, the cohort data storage space 146, and the cohort data storage space 148. A first group of kernels access the storage space 142, and this first group of kernels make up a first scheduling group or a first cohort. A second group of kernels access the storage space 144, and this second group of kernels make up a second scheduling group or a second cohort, and so forth. In an implementation, the user defines the first cohort, the second cohort, and other cohorts marking cohort boundaries in the highly parallel data application. Although four cohort data storage spaces are shown in the storage space 140, the storage space 140 includes another number of cohort data storage spaces in other implementations. In some implementations, each of the storage spaces 142-148 has a same size. In other implementations, at least one of the storage spaces 142-148 has a different size than the other storage spaces.

Since the available data storage capacity of the cache 120 is smaller than the storage space 140, it is possible that many of the memory access requests generated by the parallel data processing circuit 110 result in cache misses when these memory access requests (or memory requests) are sent to the cache 120. To increase the number of cache hits in the cache 120, the hardware, such as circuitry, of the scheduler 114 groups kernels into cohorts based on markings in the highly parallel data application provided by the user.

The scheduler 114 accesses completion time estimates of the kernels of the cohorts. The completion time estimates are provided by one or more of profiling information, estimates provided by the user, or otherwise. Using the completion time estimates, the number of wavefronts currently executing, and the number of remaining wavefronts that have not yet begun execution due to availability of hardware resources, the scheduler 114 determines whether to immediately schedule a next pending cohort or delay scheduling the next pending cohort. By doing so, the scheduler balances throughput and cache contention.

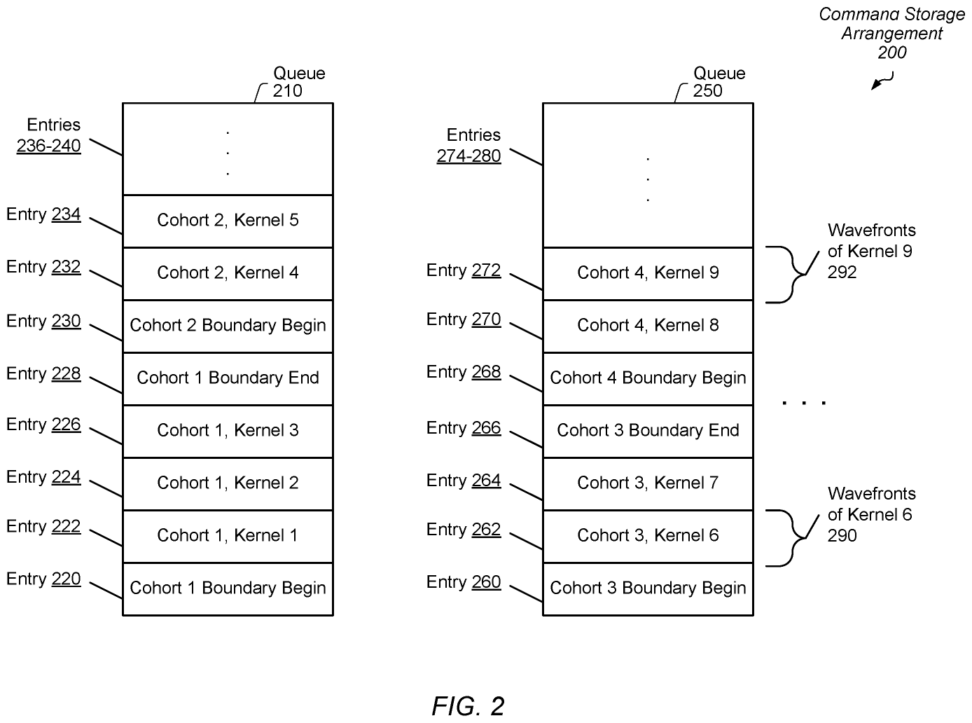

Turning now to FIG. 2, a generalized block diagram is shown of a command storage arrangement 200 that supports efficient scheduling of kernels for execution on an integrated circuit. The command storage arrangement 200 includes multiple queues, such as queues 210 and 250, storing commands in corresponding queue entries (or entries). The queues 210 and 250 are implemented with one of flip-flop circuits, one of a variety of random-access memories (RAMs), a content addressable memory (CAM), or other. Queue 210 includes entries 220-240, and queue 250 includes entries 260-280. Although two queues are shown, in other implementations, the command storage arrangement 200 another number of queues based on design requirements. In some implementations, each of the queues 210 and 250 is a separate hardware queue in a scheduler of a parallel data processing circuit. In another implementation, each of the queues 210 and 250 is a separate region of memory with each region used as a separate ring buffer. In other implementations, each of the queues 210 and 250 is a Heterogeneous System Architecture (HSA) queue used as a ring buffer that stores kernel-dispatch Architected Queueing Language (AQL) packets.

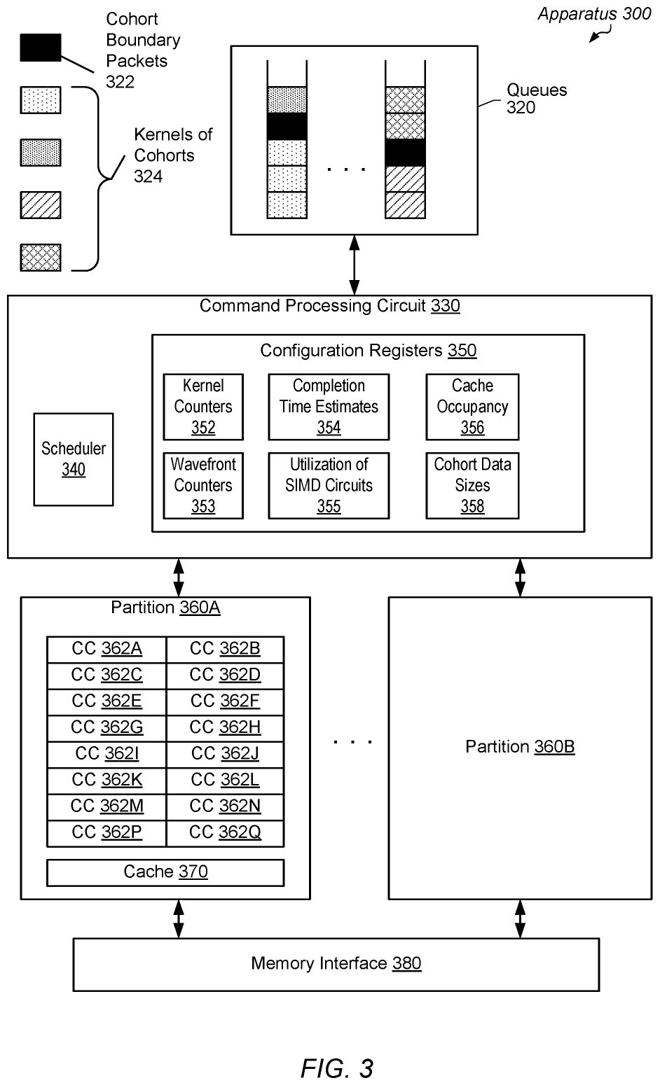

To change the scheduling of threads from a general-purpose processing circuit, such as a CPU, to a parallel data processing circuit, such as a GPU, software development kits (SDKs) and application programming interfaces (APIs) were developed for use with widely available high-level languages to provide supported function calls. The function calls provide an abstraction layer of the parallel implementation details of the parallel data processing circuit such as the parallel data processing circuit 110 (of FIG. 1) and the apparatus 300 (of FIG. 3). The details are hardware specific to the parallel data processing circuit but hidden to the developer to allow for more flexible writing of software applications. The function calls in high level languages, such as C, C++, FORTRAN, and Java and so on, are translated to commands which are later processed by the hardware in the parallel data processing circuit.

A highly parallel data application includes particular function calls using an API to allow the developer to insert a request in the highly parallel data application for launching a kernel. In an implementation, this kernel launch request is a C++ object, and it is converted to a command. In one implementation, the command is a kernel dispatch Architected Queueing Language (AQL) packet. The command is inserted in one of the queues 210 and 250. A scheduler assigns the command that launches a kernel to a compute circuit of multiple compute circuits. At least the entries 222, 224 and 226 of the queue 210 stores these types of commands (packets). In addition, a developer defines cohorts in the highly parallel data application. For example, a developer inserts a barrier indication (e.g., packet) in the highly parallel data application by using the application programming interface (API). The cohort boundary packet is visible to the user via a runtime application programming interface (API), such as the example shown below:

| | |
|---|---|
| void cohortBoundary | (hsa_queue_t* queue, |
| | bool cohortBoundaryPacketType, |
| | uint32_t cohortRegionSizeBytes, |
| | uint32_t cacheSizeBytes) |

The cohort boundary API accepts a queue handle or a reference to a stream as an argument where the packet will be inserted. Through the cohort boundary API, the user is responsible for indicating one or more of the type of the boundary packet (0: cohort boundary begin, 1: cohort boundary end), the data size of the cohort data of the particular cohort, an indication specifying whether the cache is a last-level shared cache (such as the cache 120 of FIG. 1) or a local cache (such as a cache shared by a subset of the compute circuits 112A-112B of FIG. 1), a data size of the cache, and so forth by passing these indications as arguments to the cohort boundary API. At least the entries 220, 228 and 230 of the queue 210 stores these types of commands (packets). As shown, each of the kernels includes one or more wavefronts of a corresponding cohort. The kernel labeled “Cohort 3, Kernel 6” includes the wavefronts 290 of kernel 6. The kernel labeled “Cohort 4, Kernel 9” includes the wavefronts 292 of kernel 9. The other kernels shown in the queues 210 and 250 store corresponding wavefronts of corresponding cohorts.

When kernels of a cohort are running on the multiple compute circuits, the cohort data is retained in the cache, which increases cache hits for memory requests targeting the cohort data. Data stored in the cache for the currently executing cohorts can be capacity-evicted if a compute circuit begins executing a next kernel that belongs to a different cohort and the data from kernels of currently executing cohorts occupy the entire cache. The cohort boundaries are marked by the inserted boundary packets that are inserted by the user in the application at the beginning and end of each cohort. The command interface for inserting commands utilize the HSA queues and the AQL packets, in one implementation, which allows the user or developer to customize commands (packets) for particular functionality.

In some implementations, the ‘cohort boundary begin’ command (packet) stored in entries 220 and 230 of queue 210 and in entries 260 and 268 of queue 250, mark the beginnings of cohorts. The ‘cohort boundary begin’ command (packet) indicates at least the data size of the corresponding cohort data. The ‘cohort boundary end’ command (packet) stored in entry 228 of queue 210 and in entry 266 of queue 250 marks the ends of cohorts. The ‘cohort boundary end’ commands (packets) must ensure all kernels of the cohort have completed execution. To achieve this functionality, a barrier bit in the boundary packet's header is asserted, which ensures that all the preceding packets in a corresponding queue of the queues 210 and 250 have completed execution. A cohort resides within a single queue of the queues 210 and 250. If cohorts had kernels stored across multiple queues of the queues 210 and 250, then the order of processing the ‘cohort boundary begin’ command/packet and ‘cohort boundary end’ could be mismatched, causing deadlocks. If the kernels of a cohort are independent, then the scheduler can select the kernels for execution in an out-of-order manner.

A scheduler similar to the scheduler 114 (of FIG. 1) accesses completion time estimates of kernels of the cohorts. These completion time estimates include both completion times estimated to be achieved when a corresponding data set is stored in the cache and completion times estimated to be achieved when a corresponding data set is not stored in the cache. Using the completion time estimates, the number of wavefronts currently executing, and the number of available SIMD circuits capable of being assigned wavefronts based on supporting hardware resources, the scheduler determines whether to immediately schedule a next pending cohort for dispatch and execution on the multiple compute circuits or delay scheduling the next pending cohort. For example, if the scheduler determines that the next pending cohort has one or more long running kernels and there are one or more available SIMD circuits with supporting hardware resources, the scheduler immediately schedules the next pending cohort for execution and launches kernels of the next cohort on the multiple compute circuits. Examples of the other supporting hardware resources are vector general-purpose registers, scalar general-purpose registers, a local data store, and so forth. However, when there are a relatively few available SIMD circuits with supporting hardware resources, the scheduler delays scheduling the next cohort for dispatch and execution. Delaying the scheduling reduces cache contention. When the scheduler delays scheduling the next cohort, the scheduler postpones scheduling, reduces the dispatch rate, or throttles scheduling of this next cohort for dispatch and execution. Therefore, the scheduler balances high throughput and low cache contention.

Referring to FIG. 3, a generalized block diagram is shown of an apparatus 300 that efficiently schedules kernels for execution on an integrated circuit. In the illustrated implementation, the apparatus 300 includes the queues 320, the command processing circuit 330, the partitions 360A-360B, and the memory interface 380. In some implementations, the apparatus 300 is a parallel data processing circuit such as a GPU. The queues 320 have the same data storage arrangement and functionality as the command storage arrangement 200 of the queues 210 and 250 (of FIG. 2). The memory interface 380 includes hardware, such as queues and control circuitry, that support the transfer of memory requests and memory responses with a lower-level memory. The lower-level memory can be another cache level or system memory. The hardware of the memory interface 380 also supports a communication protocol with the lower-level memory.

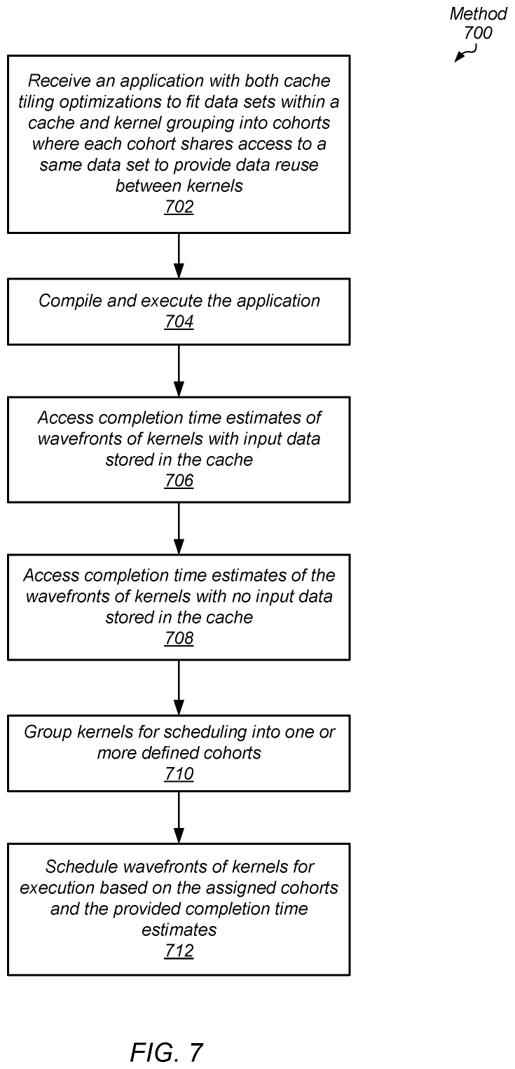

In various implementations, the circuitry of the partition 360B is a replicated instantiation of the circuitry of the partition 360A. In some implementations, each of the partitions 360A-360B is a chiplet. A further description of chiplets is later provided prior to a description of the method 700 (of FIG. 7). The partition 360A includes multiple compute circuits (CC) 362A-362Q, each having the same functionality as the compute circuits 112A-112B (of FIG. 1). The partition 360A also includes the cache 370, which is shared by the compute circuits (CC) 362A-362Q. As shown, the command processing circuit 330 includes the scheduler 340 and the configuration registers 350. The scheduler 340 has the same functionality as the scheduler 114 (of FIG. 1).

The occupied entries of the queues 320 store one of the cohort boundary packets 322 and the kernels 324 of cohorts. For each cohort in the queues 320, the kernel counters 352 maintain a count of a total number of kernels in a cohort, a count of a number of currently executing kernels of the cohort, and a count of a number of remaining kernels of the cohort. The wavefront counters 353 maintain a count of currently executing wavefronts of the kernels and a total number of wavefronts of the kernels. The cohort data sizes 358 maintains a data size of each outstanding cohort stored in the queues 320. The cohort data sizes of executing cohorts are tracked by reading the corresponding cohort boundary begin packets and the cohort boundary end packets. The cache occupancy 356 maintains a current occupancy of a particular cache such as the cache 370 of the partition 360A or another cache. The registers 355 maintain a utilization of the SIMD circuits of the compute circuits such as a ratio of the number of assigned SIMD circuits to the total number of SIMD circuits. For each outstanding cohort stored in the queues 320, the completion time estimates 354 registers maintain completion times of kernels of a particular cohort estimated to be achieved when a corresponding data set is stored in the cache. Additionally, the completion time estimates 354 registers maintain completion times of kernels of the particular cohort estimated to be achieved when a corresponding data set is not stored in the cache.

To update values stored in the completion time estimates 354 registers, the scheduler 340 can save the kernel execution times during a first pass of the kernel and use this execution time as the completion time estimates for subsequent passes. Alternatively, the scheduler 340 can use kernel execution times to estimate execution times of other similar kernels. Additionally, the scheduler 340 can receive completion time estimates for kernels as user-provided arguments in the API. Other methods for providing updates to the completion time estimates 354 registers are possible and contemplated.

Using the values stored in the configuration registers 350, the scheduler 340 determines whether to immediately schedule a next outstanding cohort that has not yet begun executing or delay scheduling of this next outstanding cohort. For example, when there are a relatively few remaining available SIMD circuits with sufficient supporting hardware resources and/or the next outstanding cohort does not have long running kernels, the scheduler 340 delays scheduling of the next outstanding cohort for dispatch and execution. However, if the scheduler 340 determines that the next outstanding cohort has one or more long running kernels and there are a sufficient number of available SIMD circuits with sufficient supporting hardware resources, the scheduler 340 immediately schedules this next outstanding cohort for dispatch and execution and launches kernels of this cohort on the multiple compute circuits 362A-362Q of one of the partitions 360A-360B.

In various implementations, the scheduler 340 determines a first duration indicating an amount of time for kernels of each currently executing cohort that are already scheduled for execution to complete with input data stored in a cache. For each currently executing cohort, the scheduler 340 finds a count of the kernels that are already scheduled for execution. For each of these kernels, the scheduler 340 determines a time difference, or delay, between a completion time estimate from the registers 354 when a corresponding data set is stored in the cache and an amount of time that has elapsed since these kernels had begun execution. If a first cohort has 8 kernels, and five of these 8 kernels are already executing, the scheduler determines the time difference, or delay, for each of these five kernels and sums them. If a second cohort has 10 kernels, and four of these 10 kernels are already executing, the scheduler determines the time difference, or delay, for each of these four kernels and sums them. The scheduler sums these delays of the five kernels of the first cohort with the delays of the four kernels of the second cohort. The total sum of the delays is the first duration. Although only two cohorts are described as being currently executing in this example, it is possible and contemplated that more cohorts are currently executing. In such a case, the scheduler 340 continues to sum the delays of the currently executing kernels of the cohorts that have already begun execution.

The scheduler 340 determines a second duration indicating an amount of time for kernels of the first cohort not yet scheduled for execution to complete without input data stored in the cache. However, this completion time estimate is for kernels of a third cohort that has not yet begun execution. This completion time estimate is not for kernels of the first cohort. As described earlier, the first cohort has 8 kernels, and five of these 8 kernels are already executing, so three of these 8 kernels are not yet executing. As described earlier, the second cohort has 10 kernels, and four of these 10 kernels are already executing, so six of these 10 kernels are not yet executing. If there are 16 compute circuits of the compute circuits 362A-362Q, and each compute circuit has one SIMD circuit, then of the 16 total SIMD circuits, nine SIMD circuits are assigned and seven SIMD circuits are available (unassigned) if there are other available hardware resources. Examples of the other hardware resources are vector general-purpose registers, scalar general-purpose registers, a local data store, and so forth.

As used herein, the term “waveslot” refers to a resource (e.g., SIMD circuit) that is assigned a wavefront to execute (e.g., based on the availability of supporting hardware resources). In the above example, there are seven unassigned SIMD circuits. If the availability of the supporting hardware resources allows all seven SIMD circuits to be assigned a corresponding wavefront, then there are seven waveslots. The scheduler 340 accesses the registers 354 and determines a completion time estimate for kernels of the third cohort with no data of the corresponding data set stored in the cache. The scheduler 340 determines a product of the seven unassigned SIMD circuits and the completion time estimate without a data set in the cache 370 for the first kernel of the third cohort. This product is the second duration.

The scheduler 340 compares the first duration and the second duration. It is noted that the first duration and the second duration are measures of time with corrective factors. For example, the first duration uses an accumulative sum of remaining delays, whereas the second duration uses a product of the completion time estimate corresponding to a data set is not stored in the cache and the number of remaining available SIMD circuits with sufficient supporting hardware resources. As described earlier, this number of remaining available SIMD circuits is a number of waveslots. If the first duration is not greater than (less than or equal to) the second duration, then the scheduler 340 schedules the third cohort for dispatch and execution on the compute circuits 362A-362Q of one of the partitions 360A-360B. However, if the first duration is greater than the second duration, then the scheduler 340 delays scheduling the third cohort for dispatch and execution. When the scheduler 340 determines the first duration is greater than the second duration, the scheduler 340 determines a dispatch rate condition is satisfied. When the scheduler 340 delays scheduling the third cohort, the scheduler 340 postpones scheduling or throttles scheduling of the third cohort. Therefore, the scheduler 340 balances high throughput and low cache contention. In some implementations, the scheduler 340 determines the first duration and the second duration and compares them based on instructions of an algorithm provided by firmware. Should the firmware be updated, the scheduler 340 can determine other values and determine whether another formula is satisfied when determining whether to schedule or delay scheduling a cohort.

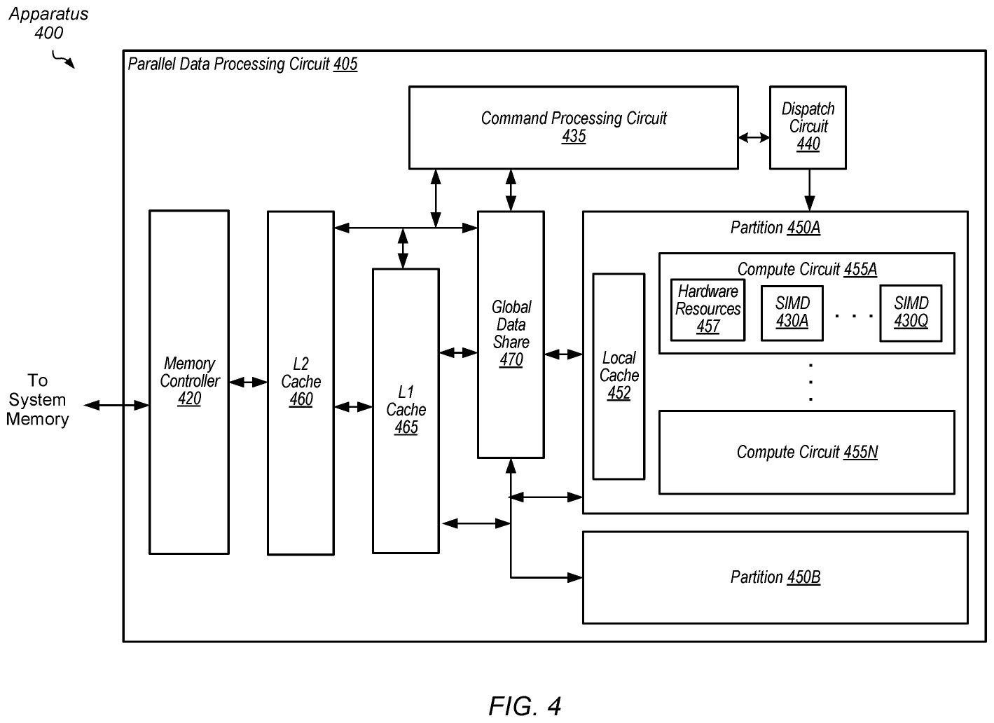

Turning now to FIG. 4, a block diagram of an implementation of an apparatus 400 is shown. In one implementation, the apparatus 400 includes the parallel data processing circuit 405 with an interface to system memory. In an implementation, the parallel data processing circuit 405 is a GPU. Multiple processes of a highly parallel data application provide multiple kernels to be executed on the compute circuits 455A-455N. Each kernel corresponds to a function call of the highly parallel data application. The parallel data processing circuit 405 includes at least the command processing circuit (or command processor) 435, dispatch circuit 440, compute circuits 455A-455N, memory controller 420, global data share 470, shared level one (L1) cache 465, and level two (L2) cache 460.

It should be understood that the components and connections shown for the parallel data processing circuit 405 are merely representative of one type processing circuit and does not preclude the use of other types of processing circuits for implementing the techniques presented herein. The apparatus 400 also includes other components which are not shown to avoid obscuring the figure. In other implementations, the parallel data processing circuit 405 includes other components, omits one or more of the illustrated components, has multiple instances of a component even if only one instance is shown in the apparatus 400, and/or is organized in other suitable manners. Also, each connection shown in the apparatus 400 is representative of any number of connections between components. Additionally, other connections can exist between components even if these connections are not explicitly shown in the apparatus 400.

In various implementations, the apparatus 400 executes any of various types of highly parallel data applications. Based on an algorithm developed by a software programmer, the application includes cache tiling optimizations to fit data sets within a cache such as the cache 452. Additionally, based on the algorithm developed by a software programmer, the application includes kernels (function calls) being grouping into cohorts where each cohort shares access to a same data set to provide data reuse between kernels. As described earlier, the application includes instructions that set cohort boundaries and includes commands (packets). The cohort boundary packet is visible to the user via a runtime application programming interface (API), such as the example shown below:

| | |
|---|---|
| void cohortBoundary | (hsa_queue_t* queue, |
| | bool cohortBoundaryPacketType, |
| | uint32_t cohortRegionSizeBytes, |
| | uint32_t cacheSizeBytes) |

Through the cohort boundary API, the user is responsible for indicating one or more of the type of the boundary packet (0: cohort boundary begin, 1: cohort boundary end), the data size of the cohort data of the particular cohort, an indication specifying whether the cache is an external last-level shared cache (such as the cache 120 of FIG. 1) or a local cache (such as the cache 452), and a data size of the cache by passing these indications as arguments to the cohort boundary API. As part of executing an application, a host CPU (not shown) launches kernels to be executed by the parallel data processing circuit 405.

In some implementations, the parallel data processing circuit 405 does not include one or more of the global data share 470, shared L1 cache 465, and L2 cache 460. In an implementation, the memory controller 420 directly communicates with each of the partitions 450A-450B similar to the memory interface 380 directly communicating with the partitions 360A-360B (of FIG. 3). Threads within wavefronts executing on compute circuits 455A-455N read data from and write data to the cache 452, vector general-purpose registers, scalar general-purpose registers, and when present, the global data share 470, the shared L1 cache 465, and the L2 cache 460. When present, it is noted that L1 cache 465 can include separate structures for data and instruction caches. It is also noted that global data share 470, shared L1 cache 465, L2 cache 460, memory controller 420, system memory, and cache 452 can collectively be referred to herein as a “cache memory subsystem”.

In various implementations, the circuitry of the partition 450B is a replicated instantiation of the circuitry of the partition 450A. In some implementations, each of the partitions 450A-450B is a chiplet. A further description of chiplets is later provided prior to a description of the method 700 (of FIG. 7). In an implementation, the local cache 452 represents a last level shared cache structure such as a local level-two (L2) cache within the partition 450A. Additionally, each of the multiple compute circuits 455A-455N includes SIMD circuits 430A-430Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on a same instruction, but different data, such as a different data item, associated with a different thread.

In addition to the SIMD circuits 430A-430Q, the compute circuit 455A also includes the hardware resources 457. The hardware resources 457 include at least an assigned number of vector general-purpose registers (VGPRs) per thread, an assigned number of scalar general-purpose registers (SGPRs) per wavefront, and an assigned data storage space of a local data store per workgroup. Each of the compute circuits 455A-455N receives wavefronts from the dispatch circuit 440 and stores the received wavefronts in a corresponding local dispatch circuit (not shown). A local scheduler within the compute circuits 455A-455N schedules these wavefronts to be dispatched from the local dispatch circuits to the SIMD circuits 430A-430Q.

As described earlier, in some implementations, the command processing circuit 435 receives kernels from the host CPU and determines when dispatch circuit 440 dispatches wavefronts of these kernels to the compute circuits 455A-455N. In various implementations, the command processing circuit 435 has the same functionality as the scheduler 114 (of FIG. 1) and the scheduler 340 (of FIG. 3). In some implementations, a copy of instructions of firmware is stored in one or more of the global data share 470, shared L1 cache 465, and L2 cache 460, and when the circuitry of the command processing circuit 435 executes these instructions, the command processing circuit 435 determines when the dispatch circuit 440 dispatches wavefronts of these kernels to compute circuits 455A-455N.

Based on the commands (packets) in the application, the command processing circuit 435 groups particular kernels together in a cohort that accesses a same data set different from a data set of another cohort. Rather than schedule the kernels as soon as hardware resources (hardware resources 457 and SIMD circuits 430A-430Q) of the compute circuits 455A-455N are available to increase throughput, the command processing circuit 435 instead, at times, delays scheduling of multiple kernels of some cohorts to minimize cache contention in the local cache 452. The cache 452 can be a last level shared cache structure of the partition 450A. When the circuitry of the command processing circuit 435 executes the instructions of firmware, in various implementations, the command processing circuit 435 attempts to balance high throughput and low cache contention. When kernels of a particular cohort are scheduled for execution and begin executing on the assigned compute circuits of the compute circuits 455A-455N, the cohort data is retained in the cache 452, which maximizes cache hits for memory requests generated by the cohorts targeting the cohort data. Data for the currently executing cohorts can be capacity-evicted if a compute circuit begins executing a kernel of a new cohort and the cohort data of the currently executing cohorts occupy the entire local cache 452.

When the circuitry of the command processing circuit 435 executes the instructions of firmware, in various implementations, the command processing circuit 435 accesses completion time estimates of kernels of the cohorts. These completion time estimates include both completion times estimated to be achieved when a corresponding data set is stored in the cache 452 and completion times estimated to be achieved when a corresponding data set is not stored in the cache 452. Using the completion time estimates, the number of kernels currently executing, and the number of remaining kernels that have not yet begun execution of each currently scheduled cohort, the command processing circuit 435 determines whether to immediately schedule a next cohort or delay scheduling the next cohort. For example, when there are a relatively few remaining kernels of the currently scheduled cohorts to execute, the command processing circuit 435 delays scheduling the next cohort for execution. However, if the command processing circuit 435 determines that the next cohort has one or more long running kernels, the command processing circuit 435 immediately schedules the next cohort for execution and launches kernels of the next cohort on one or more available SIMD circuits 430A-430Q of the compute circuits 455A-455N.

The actual number of SIMD circuits 430A-430Q of the compute circuits 455A-455N being available for a next cohort depends on a number of unassigned SIMD circuits 430A-430Q of the compute circuits 455A-455N and the availability of the hardware resources 457 of the compute circuits 455A-455N. For example, the number of SIMD circuits 430A-430Q available for assignment is less when the next cohort requests 50 scalar general purpose-registers (SGPRs), 256 vector general-purpose registers (VGPRs), and 32 megabytes (MB) of a local data store (LDS) than when the next cohort requests 20 SGPRs, 128 VGPRs, and 32 MB of LDS.

When the circuitry of the command processing circuit 435 executes the instructions of firmware, in various implementations, the command processing circuit 435 determines whether a dispatch rate condition is satisfied. The command processing circuit 435 determines that the dispatch rate condition is satisfied when a first duration is greater than a second duration. At the beginning of scheduling window, the command processing circuit 435 determines the first duration and the second duration, and then compares them. To determine the first duration, the command processing circuit 435 determines an accumulative sum of one or more products with each product being a number of wavefronts of each kernel executing on the SIMD circuits 430A-430Q of the compute circuits 455A-455N and a corresponding remaining amount of time for completion of these kernels with a corresponding data set stored in the cache 452.

To determine the second duration, the command processing circuit 435 determines a product of a number of available (unassigned) SIMD circuits of the SIMD circuits 430A-430Q of the compute circuits 455A-455N and an amount of time for a wavefront of a kernel of a next pending cohort to complete without a corresponding data set yet stored in the cache 452. If the first duration is greater than the second duration, the command processing circuit 435 delays scheduling the next pending cohort. By delaying the scheduling of the next pending cohort, the command processing circuit 435 reduces the dispatch rate of kernels (and corresponding wavefronts) to the compute circuits 455A-455N of the partitions 450A-450B.

The length of the scheduling delay of the next pending cohort, which reduces the dispatch rate of cohorts (and corresponding kernels and wavefront), by the command processing circuit 435 is a duration of a scheduling window, a duration stored in a programmable configuration register, or other. The length of the scheduling delay of the next pending cohort can also be based on a change in the number of executing wavefronts on assigned SIMD circuits of the SIMD circuits 430A-430Q of the compute circuits 455A-455N being greater than a threshold. The length of the scheduling delay of the next pending cohort can also be based on a change in the number of executing cohorts.

In an example, there is a first cohort, which is referred to as Cohort 1, that has 10 kernels, each with 8 wavefronts. Therefore, Cohort 1 has 80 total wavefronts. These 10 kernels and 80 wavefronts of Cohort 1 are stored in a scheduling queue referred to as Queue 1. The scheduling queue has the same functionality as the queues 210 and 250 (of FIG. 2) and the queues 320 (of FIG. 3). A second cohort (Cohort 2) has 6 kernels, each with 4 wavefronts. Therefore, Cohort 2 has 24 total wavefronts. These 6 kernels and 24 wavefronts of Cohort 2 are stored in a scheduling queue referred to as Queue 2. A third cohort (Cohort 3) has 8 kernels, each with 5 wavefronts. Therefore, Cohort 3 has 40 total wavefronts. These 8 kernels and 40 wavefronts of Cohort 3 are stored in a scheduling queue referred to as Queue 3. Each of Cohort 1 and Cohort 2 has already begun execution. Cohort 3 is a next pending cohort to consider for scheduling by the command processing circuit 435.

The command processing circuit 435 selected Cohort 3 as the next pending cohort based on a priority level of the cohort. A corresponding priority level of a cohort is based on one or more of an age of the cohort, a quality of service (QOS) parameter of the cohort, a data size of the data set (tile, cohort data) of the cohort, a ratio of the corresponding data size of the data set to the available data storage space in the cache 452, an application identifier or type, such as a real-time application, and so forth. Each of the partitions 450A-450B has 16 compute circuits 455A-455N, each with 8 SIMD circuits 430A-430Q. Therefore, each of the partitions 450A-450B has 128 SIMD circuits 430A-430Q, and can simultaneously execute 128 wavefronts.

Regarding partition 450A, Cohort 1 currently has 68 in-flight wavefronts currently executing, and therefore, Cohort 1 has 12 remaining wavefronts that are pending in Queue 1. Cohort 2 currently has 18 in-flight wavefronts currently executing, and therefore, Cohort 2 has 6 remaining wavefronts that are pending in Queue 2. With a sum of 68 in-flight wavefronts and 18 in-flight wavefronts, there are 86 in-flight wavefronts currently executing in partition 450A. Therefore, for partition 450A, there are 86 SIMD circuits of the 128 SIMD circuits 430A-430Q currently assigned and executing wavefronts. For partition 450A, there are 42 available (unassigned) SIMD circuits of the 128 SIMD circuits 430A-430Q.

As described earlier, at the beginning of a scheduling window, the command processing circuit 435 determines the first duration and the second duration, and then compares them. To determine the first duration, the command processing circuit 435 determines an accumulative sum of one or more products with each product being a number of wavefronts of each kernel executing on the SIMD circuits 430A-430Q of the compute circuits 455A-455N and a corresponding remaining amount of time for completion of these kernels with a corresponding data set stored in the cache 452. To determine the corresponding remaining amounts of time, the command processing circuit 435 accesses completion time estimates of kernels of the cohorts with corresponding data sets stored in the cache 452. These completion time estimates are stored in registers, a region of memory, a table, or other. The command processing circuit 435 determines a difference between a completion time estimate of a kernel of a cohort with a corresponding data set stored in the cache 452 and an amount of time that has elapsed since the kernels had begun execution. This remaining amount of time for completion of a kernel of a cohort with a corresponding data set stored in the cache 452 can be indicated as “Trem_cached.”

For the above example, the command processing circuit 435 determines the first duration is (8 SIMD circuits assigned to Kernel 1 of Cohort 1)×(Trem_cached for Kernel 1 of Cohort 1)+(8 SIMD circuits assigned to Kernel 2 of Cohort 1)×(Trem_cached for Kernel 2 of Cohort 1)+ . . . +(8 SIMD circuits assigned to Kernel 8 of Cohort 1)×(Trem_cached for Kernel 8 of Cohort 1)+(4 SIMD circuits assigned to Kernel 9 of Cohort 1)×(Trem_cached for Kernel 9 of Cohort 1)+(4 SIMD circuits assigned to Kernel 1 of Cohort 2)×(Trem_cached for Kernel 1 of Cohort 2)+(4 SIMD circuits assigned to Kernel 2 of Cohort 2)×(Trem_cached for Kernel 2 of Cohort 2)+ . . . +(4 SIMD circuits assigned to Kernel 4 of Cohort 2)×(Trem_cached for Kernel 4 of Cohort 2)+(2 SIMD circuits assigned to Kernel 5 of Cohort 2)×(Trem_cached for Kernel 5 of Cohort 2).

For the above example, the command processing circuit 435 determines the difference between the 128 total SIMD circuits and the 86 assigned SIMD circuits is 42 available (unassigned) SIMD circuits of the SIMD circuits 430A-430Q of the compute circuits 455A-455N. However, since there are only 40 wavefronts of Cohort 3 stored in Queue 3, the command processing circuit 435 uses the value of 40 SIMD circuits. The command processing circuit 435 accesses completion time estimates of kernels of the cohorts without corresponding data sets stored in the cache 452. These completion time estimates are stored in registers, a region of memory, a table, or other. This completion time estimate of a kernel of the next pending cohort without a corresponding data set stored in the cache 452 can be indicated as “Tuncached.”

The command processing circuit 435 determines the second duration is (5 SIMD circuits to be assigned to Kernel 1 of Cohort 3)×(Tuncached for Kernel 1 of Cohort 3)+ (5 SIMD circuits to be assigned to Kernel 2 of Cohort 3)×(Tuncached for Kernel 2 of Cohort 3)+ . . . + (5 SIMD circuits to be assigned to Kernel 8 of Cohort 3)×(Tuncached for Kernel 8 of Cohort 3). If there is a pending Cohort 4, then the remaining 2 unassigned SIMD circuits of the SIMD circuits 430A-430Q of the compute circuits 455A-455N can be assigned to two wavefronts of the first kernel of Cohort 4. The command processing circuit 435 would accordingly increase the second duration based on these two additionally assigned SIMD circuits. Afterward, the command processing circuit 435 compares the first duration and the second duration. If the first duration is less than or equal to the second duration, then the command processing circuit 435 dispatches Cohort 3 to the partition 450A. However, if the first duration is greater than the second duration, then the command processing circuit 435 delays dispatching Cohort 3 to the partition 450A. In such a case, the command processing circuit 435 reduces the dispatch rate for the partition 450A.

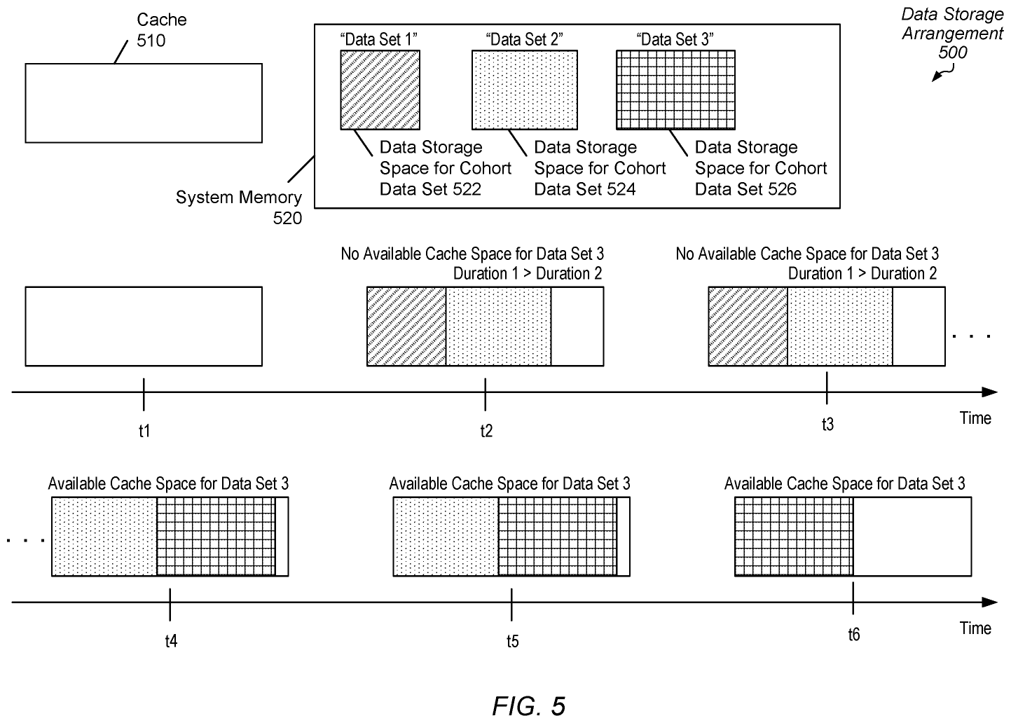

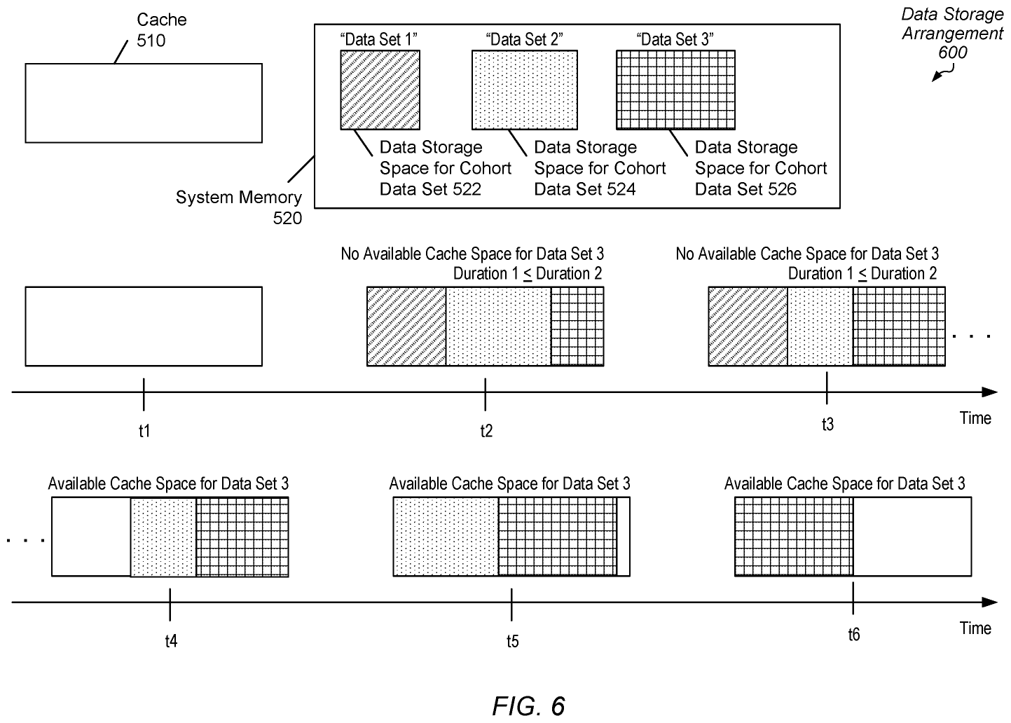

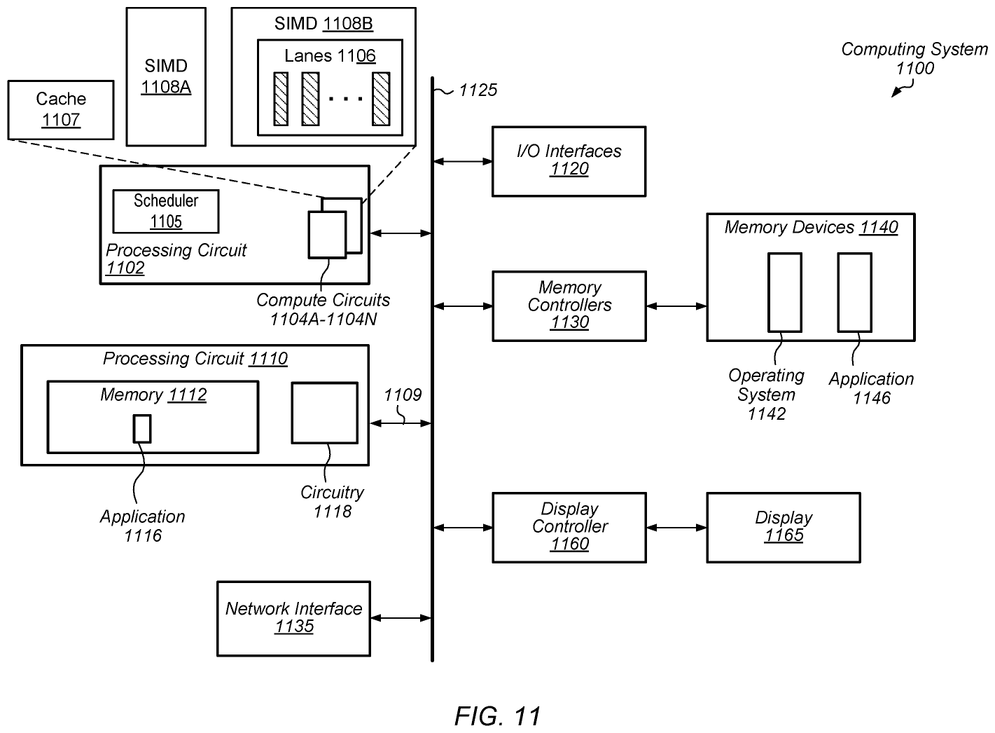

Referring to FIG. 5 and FIG. 6, generalized block diagrams are shown of data storage arrangement 500 and data storage arrangement 600 as a scheduler efficiently schedules kernels for execution on an integrated circuit. The system memory 520 includes data storage space for cohort data set 522 (“Data Set 1”), data storage space for cohort data set 524 (“Data Set 2”), and data storage space for cohort data set 526 (“Data Set 3”). In some implementations, the cache 510 can be used as a shared last-level cache in a compute circuit similar to the cache 370 (of FIG. 3), the cache 452 (of FIG. 4), and the cache 1107 (of FIG. 11). In other implementations, the cache 510 is an external last-level shared cache (such as the cache 120 of FIG. 1).

At the point-in-time t1 (or time t1), the cache 510 does not yet store any data sets corresponding to cohorts. At time t2, a scheduler (not shown) schedules Cohort 1 and Cohort 2 to SIMD circuits of compute circuits, and these cohorts use the Data Set 1 and the Data Set 2. The sum of the data sizes of the Data Set 1 and the Data Set 2 fit within the cache 510. The data size of the Data Set 3 does not fit in the cache 510. The scheduler has the same functionality as the scheduler 114 (of FIG. 1), the scheduler 340 (of FIG. 3), and the command processing circuit 435 (of FIG. 4). For example, this scheduler balances high throughput and low cache contention. It is noted that as the data of the Data Set 1 and Data Set 2 are loaded into the cache 510, a prefetcher in the corresponding cache controller can detect a memory access pattern and perform prefetching as a result.

To determine whether to delay dispatching Cohort 3 that uses the Data Set 3, the scheduler determines whether a dispatch rate condition is satisfied. The scheduler determines that the dispatch rate condition is satisfied when a first duration is greater than a second duration. To determine the first duration and the second duration, in some implementations, the scheduler performs steps described in an earlier example for the command processing circuit 435 (of FIG. 4). For example, the first duration indicates an amount of time for kernels of each currently executing cohort that are already scheduled for execution to complete with input data stored in a cache. The second duration indicates an amount of time for kernels of a next pending cohort not yet scheduled for execution to complete without input data stored in the cache.

At time t2, the scheduler determines that the first duration (“Duration 1”) is greater than the second duration (“Duration 2”). Therefore, the scheduler delays scheduling Cohort3 for dispatch and execution. At time t3, Cohort 1 and Cohort 2 continue execution, and the scheduler still determines that Duration 1 is greater than Duration 2. Therefore, the scheduler delays scheduling Cohort3 for dispatch and execution. At time t4, Cohort 1 has completed execution and data storage in the cache 510 has become available. The scheduler schedules Cohort3 for dispatch and execution, and over time, a copy of Data Set 3 is loaded from the system memory 520 to the cache 510. For example, the least recently used (LRU) value of the cache line of Data Set 1 indicate that the corresponding data can be evicted.

It is noted that the storage placement shown is for illustrative purposes, and it is understood that Data Set 2 does not need to move and the data of Data Set 2 and Data Set 3 is not necessarily stored in a contiguous manner throughout the cache 510. At time t5, Cohort 2 and Cohort 3 continue execution. No other pending cohort is yet ready for execution. At time t6, Cohort 2 has completed execution and data storage in the cache 510 has become available. Turning now to the data storage arrangement 600, data and circuitry described earlier are numbered identically. At time t1 the cache 510 does not yet store any data sets corresponding to cohorts.

At time t2, the scheduler schedules Cohort 1 and Cohort 2 to SIMD circuits of compute circuits, and these cohorts use the Data Set 1 and the Data Set 2. The sum of the data sizes of the Data Set 1 and the Data Set 2 fit within the cache 510. The data size of the Data Set 3 does not fit in the cache 510. At time t2, the scheduler determines that Duration 1 is less than or equal to Duration 2. A different number of executing wavefronts and different completion time estimates can cause the difference in the result of the dispatch rate condition. Therefore, the scheduler schedules Cohort3 for dispatch and execution. Accordingly, the cache 510 begins to store at least a portion of the Data Set 3. At time 3, data contention has been occurring. As shown, the amount of data storage space for Data Set 3 has grown in the cache 510, whereas the amount of storage space for Data Set 2 has reduced. It is possible that the amount of storage space for Data Set 1 has also decreased.

At time t4, Cohort 1 has completed execution and data storage in the cache 510 has become available. For example, the least recently used (LRU) value of the cache line of Data Set 1 indicate that the corresponding data can be evicted. At time t5, Cohort 2 and Cohort 3 continue execution. No other pending cohort is yet ready for execution. The amount of data storage space for Data Set 2 and Data Set 3 has grown in the cache 510. At time t6, Cohort 2 has completed execution and data storage in the cache 510 has become available.

Before describing methods used to efficiently schedule kernels for execution on an integrated circuit, a further description of the use of chiplets in the integrated circuit is provided. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet.

A second silicon wafer (or second wafer) is fabricated with multiple instantiated copies of integrated circuitry of a second chiplet, and this second wafer is diced using laser cutting techniques to separate the multiple copies of the second chiplet. The first chiplet provides functionality different from the functionality of the second chiplet. One or more copies of the first chiplet are placed in an integrated circuit, and one or more copies of the second chiplet is placed in the integrated circuit. The first chiplet and the second chiplet are interconnected to one another within a corresponding MCM. Such a process replaces a process that fabricates a third silicon wafer (or third wafer) with multiple copies of a single, monolithic semiconductor die that includes the functionality of the first chiplet and the second chiplet as integrated functional blocks within the single, monolithic semiconductor die.

Process yield of single, monolithic dies on a silicon wafer is lower than process yield of smaller chiplets on a separate silicon wafer. In addition, a semiconductor process can be adapted for the particular type of chiplet being fabricated. With single, monolithic dies, each die on the wafer is formed with the same fabrication process. However, it is possible that an interface functional block does not require process parameters of a semiconductor manufacturer's expensive process that provides the fastest devices and smallest geometric dimensions. With separate chiplets, designers can add or remove chiplets for particular integrated circuits to readily create products for a variety of performance categories. In contrast, an entire new silicon wafer must be fabricated for a different product when single, monolithic dies are used. It is possible and contemplated that one or more of the processing circuits, the compute circuits, and apparatuses illustrated in FIGS. 1, 3-4 and 11 are implemented as chiplets.

In some implementations, the hardware of the processing circuits and the apparatuses illustrated in FIGS. 1, 3-4 and 11 is provided in a two-dimensional (2D) integrated circuit (IC) with the dies placed in a 2D package. In other implementations, the hardware is provided in a three-dimensional (3D) stacked integrated circuit (IC). A 3D integrated circuit includes a package substrate with multiple semiconductor dies (or dies) integrated vertically on top of it. Utilizing three-dimensional integrated circuits (3D ICs) further reduces latencies of input/output signals between functional blocks on separate semiconductor dies. It is noted that although the terms “left,” “right,” “horizontal,” “vertical,” “row,” “column,” “top,” and “bottom” are used to describe the hardware, the meaning of the terms can change as the integrated circuits are rotated or flipped.

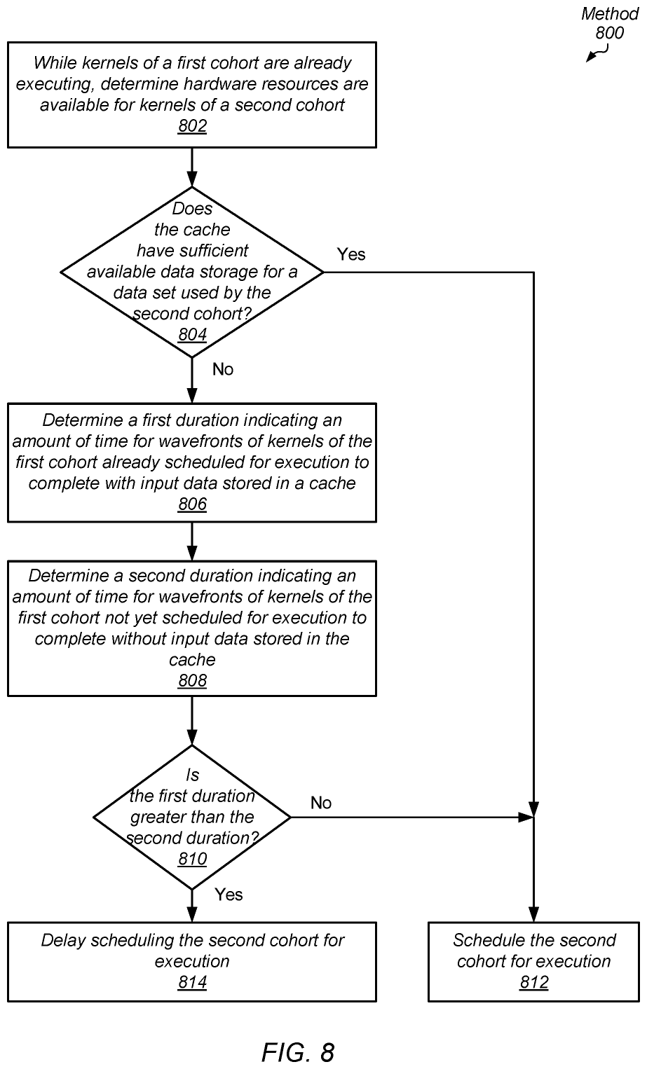

Regarding the methods 700-1000 (of FIGS. 7-10), a computing system includes a cache and a processing circuit with multiple, replicated compute circuits and a scheduler. In some implementations, the processing circuit is a parallel data processing circuit, and each of the multiple, replicated compute circuits includes the circuitry of multiple lanes of execution. The processing circuit executes commands translated from instructions of a highly parallel data application. Referring to FIG. 7, a generalized block diagram is shown of a method 700 for efficiently scheduling kernels for execution on an integrated circuit. For purposes of discussion, the steps in this implementation (as well as FIGS. 8-10) are shown in sequential order. However, in other implementations some steps occur in a different order than shown, some steps are performed concurrently, some steps are combined with other steps, and some steps are absent.

The circuitry of a host processing circuit receives an application with both cache tiling optimizations to fit data sets within a cache and kernel groupings into cohorts where each cohort shares access to a same data set to provide data reuse between kernels (block 702). The application includes kernels (function calls) being grouped into cohorts where each cohort shares access to the same data set to provide data reuse between kernels. As described earlier, the application includes instructions that set cohort boundaries and includes commands (packets). The cohort boundary packet is visible to the user via a runtime application programming interface (API). The host processing circuit compiles the application, which includes translating certain instructions into commands executed by a parallel data processing circuit.

The hardware, such as circuitry, of a scheduler of the processing circuit accesses completion time estimates of one or more of kernels and wavefronts of kernels with input data stored in the cache (block 706). In various implementations, the processing circuit is a GPU or another type of parallel data processing circuit, and the scheduler is circuitry within a command processing circuit. In some implementations, the circuitry of the scheduler executes instructions of firmware that includes an algorithm for balancing throughput and cache contention. The scheduler accesses completion time estimates of the wavefronts of kernels with no input data stored in the cache (block 708). The scheduler groups kernels into one or more cohorts (block 710).

The scheduler schedules wavefronts of kernels for execution based on the assigned cohorts and the provided completion time estimates (block 712). For example, if the scheduler determines that the next cohort has one or more long running kernels, the scheduler immediately schedules the next cohort for execution and launches kernels of the next cohort on the multiple compute circuits. However, when there are a relatively few remaining kernels of the currently scheduled cohorts, the scheduler delays scheduling the next cohort for execution. When the scheduler delays scheduling the next cohort, the scheduler postpones scheduling or throttles scheduling of this next cohort. Therefore, the scheduler balances high throughput and low cache contention.

Referring to FIG. 8, a generalized block diagram is shown of a method 800 for efficiently scheduling kernels for execution on an integrated circuit. While kernels of a first cohort are already executing, a scheduler determines kernels of a second cohort are ready to be scheduled for execution (block 802). In other words, the scheduler determines the kernels of the second cohort are ready to be dispatched. If the cache has sufficient available data storage for a data set used by the second cohort (“yes” branch of the conditional block 804), then the scheduler schedules the second cohort for execution (block 812). However, if the cache does not have sufficient available data storage for the second cohort (“no” branch of the conditional block 804), then the scheduler determines a first duration indicating an amount of time for wavefronts of kernels of the first cohort already scheduled for execution to complete with input data stored in a cache (block 806). Although a single cohort is described as being currently executing in this example, it is possible and contemplated that more cohorts are currently executing. In such a case, the scheduler continues to sum up the delays of the currently executing kernels of the cohorts that have already begun execution. In some implementations, the scheduler sums delays of each currently executing cohort as described earlier for scheduler 340 (of FIG. 3) and the command processing circuit 435 (of FIG. 4). For example, the scheduler determines the first duration using the formula described earlier that is determined by the command processing circuit 435 (of FIG. 4).

The scheduler determines a second duration indicating an amount of time for available (unassigned) SIMD circuits of the compute circuits to begin and complete execution without data corresponding data set of the second cohort stored in the cache (block 808). This completion time estimate is for kernels of the second cohort that has not yet begun execution. This completion time estimate is not for kernels of the first cohort. In various implementations, the scheduler determines the second duration using the formula described earlier that is determined by the command processing circuit 435 (of FIG. 4). The scheduler determines the sum of available (unassigned) SIMD circuits of the compute circuits. The scheduler determines a product of this sum and the completion time estimate for kernels of the second cohort that have not yet begun execution when corresponding cohort data is not stored in the cache. This product is the second duration. If the first duration is not greater than the second duration (“no” branch of the conditional block 810), then the scheduler schedules the second cohort for execution (block 812). However, if the first duration is greater than the second duration (“yes” branch of the conditional block 810), then the scheduler delays scheduling the second cohort for execution (block 814).

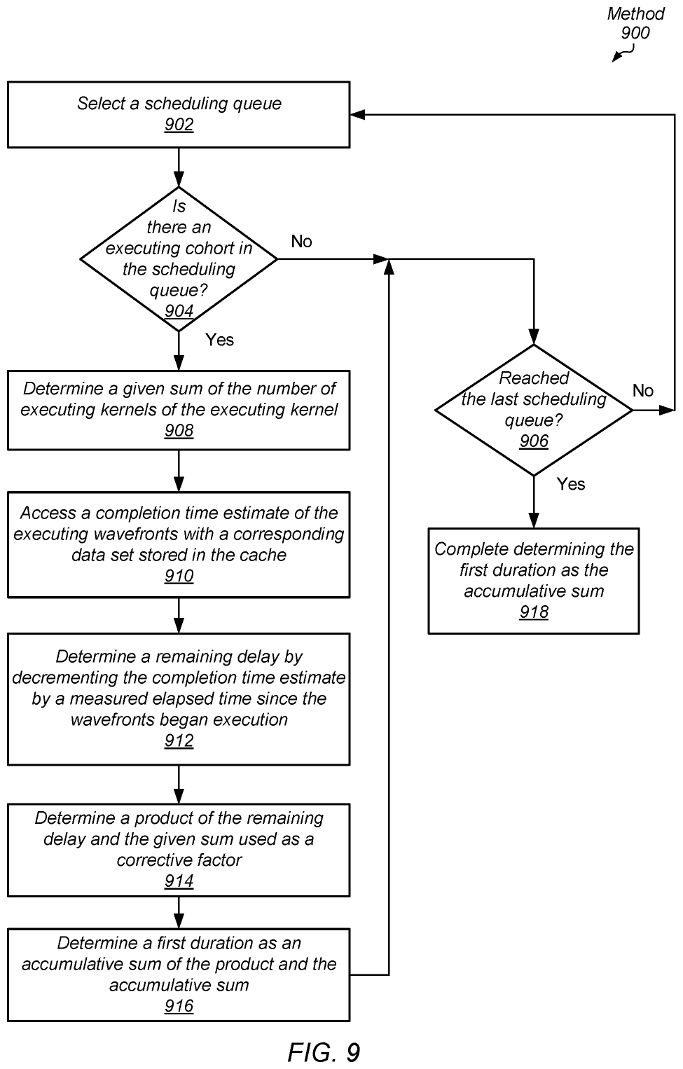

Referring to FIG. 9, a generalized block diagram is shown of a method 900 for determining a portion of a dispatch rate condition used for efficiently scheduling kernels for execution on an integrated circuit. A scheduler, such as a command processing circuit of a parallel data processing circuit, determines that a dispatch rate condition is satisfied when a first duration is greater than a second duration. The steps of method 900 describe techniques used to determine the first duration. At the beginning of a scheduling window, the circuitry of the scheduler executes instructions of firmware that cause the scheduler to determine the first duration. The scheduler selects a scheduling queue (block 902). In various implementations, the parallel data processing circuit has access to multiple scheduling queues with the same functionality as the queues 210 and 250 (of FIG. 2) and the queues 320 (of FIG. 3).

If there is not an executing cohort in the scheduling queue (“no” branch of the conditional block 904), and if the last scheduling queue has not yet been reached (“no” branch of the conditional block 906), then control flow of method 900 returns to block 902 where a next scheduling queue is selected. If there is an executing cohort in the scheduling queue (“yes” branch of the conditional block 904), then the scheduler determines a given sum of the number of executing kernels of the executing kernel (block 908). The scheduler accesses a completion time estimate of the executing wavefronts with a corresponding data set stored in the cache (block 910). The scheduler determines a remaining delay by decrementing the completion time estimate by a measured elapsed time since the wavefronts began execution (block 912).

The scheduler determines a product of the remaining delay and the given sum used as a corrective factor (block 914). The scheduler determines the first duration as an accumulative sum of the product and the accumulative sum (block 916). Afterward, control flow of method 900 moves to block conditional block 906. If there is not an executing cohort in the scheduling queue (“no” branch of the conditional block 904), and if the last scheduling queue has been reached (“yes” branch of the conditional block 906), then the scheduler completes determining the first duration as the accumulative sum (block 918).

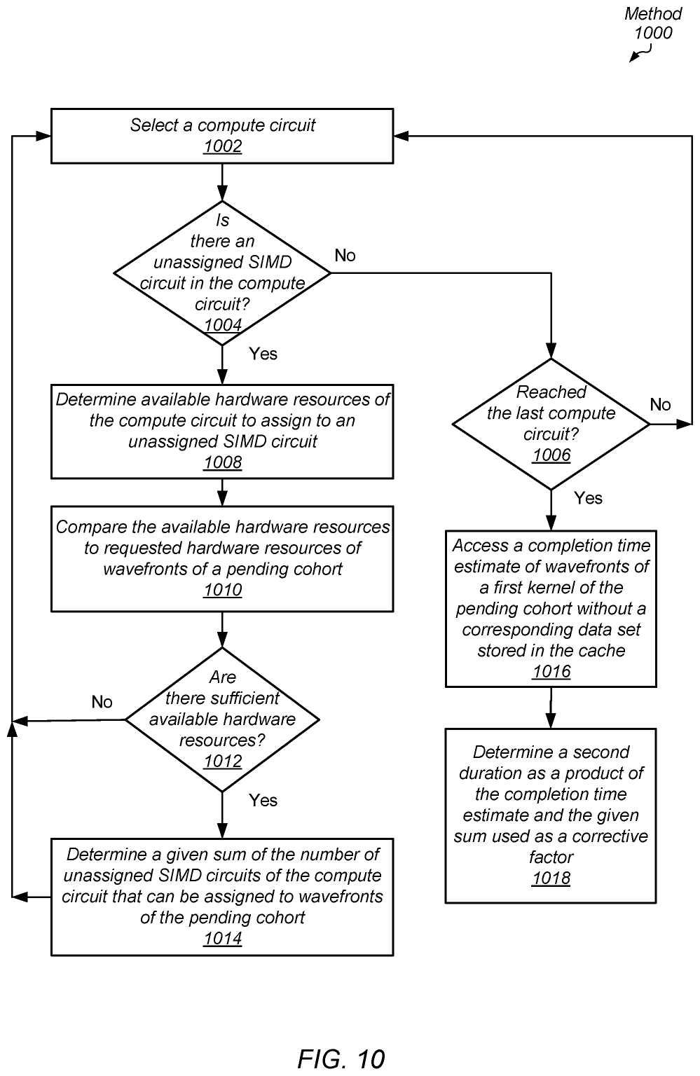

Referring to FIG. 10, a generalized block diagram is shown of method 1000 for determining a portion of a dispatch rate condition used for efficiently scheduling kernels for execution on an integrated circuit. A scheduler, such as a command processing circuit of a parallel data processing circuit, determines that a dispatch rate condition is satisfied when a first duration is greater than a second duration. The steps of method 1000 describe techniques used to determine the second duration. At the beginning of a scheduling window, the circuitry of the scheduler executes instructions of firmware that cause the scheduler to determine the second duration. The scheduler selects a compute circuit (block 1002).

If there is no unassigned SIMD circuit in the selected compute circuit (“no” branch of the conditional block 1004), and if the last compute circuit has not yet been reached (“no” branch of the conditional block 1006), then control flow of method 1000 returns to block 1002 where a next compute circuit is selected. If there is an unassigned SIMD circuit in the compute circuit (“yes” branch of the conditional block 1004), then the scheduler determines available hardware resources of the compute circuit to assign to an unassigned SIMD circuit (block 1008).

The scheduler compares the available hardware resources to requested hardware resources of wavefronts of a pending cohort (block 1010). If there is insufficient available hardware resources (“no” branch of the conditional block 1012), then control flow of method 1000 returns to block 1002 where a next compute circuit is selected. However, if there are sufficient available hardware resources (“yes” branch of the conditional block 1012), then the scheduler determines a given sum of the number of unassigned SIMD circuits of the compute circuit that can be assigned to wavefronts of the pending cohort based on the available hardware resources (block 1014). For example, the number of SIMD circuits available for assignment is less when the next pending cohort requests 50 scalar general purpose-registers (SGPRs), 256 vector general-purpose registers (VGPRs), and 32 megabytes (MB) of a local data store (LDS) than when the next pending cohort requests 20 SGPRs, 128 VGPRs, and 32 MB of LDS. Afterward, control flow of method 1000 returns to block 1002 where a next compute circuit is selected.

If there is no unassigned SIMD circuit in the compute circuit (“no” branch of the conditional block 1004), and if the last compute circuit has been reached (“yes” branch of the conditional block 1006), then the scheduler accesses a completion time estimate of wavefronts of a first kernel of the next pending cohort without a corresponding data set stored in the cache (block 1016). The scheduler determines a second duration as a product of the completion time estimate and the given sum used as a corrective factor (block 1018).

Turning now to FIG. 11, a generalized diagram is shown of an implementation of a computing system 1100 that efficiently schedules wavefronts for execution on an integrated circuit. In an implementation, the computing system 1100 includes at least processing circuits 1102 and 1110, input/output (I/O) interfaces 1120, bus 1125, network interface 1135, memory controllers 1130, memory devices 1140, display controller 1160, and display 1165. In other implementations, computing system 1100 includes other components and/or computing system 1100 is arranged differently. For example, power management circuitry, and phased locked loops (PLLs) or other clock generating circuitry are not shown for ease of illustration. In various implementations, the components of the computing system 1100 are on the same die such as a system-on-a-chip (SOC). In other implementations, the components are individual dies in a system-in-package (SiP) or a multi-chip module (MCM). A variety of computing devices use the computing system 1100 such as a desktop computer, a laptop computer, a server computer, a tablet computer, a smartphone, a gaming device, a smartwatch, and so on.

Processing circuits 1102 and 1110 are representative of any number of processing circuits which are included in computing system 1100. In an implementation, processing circuit 1110 is a general-purpose CPU. In one implementation, the processing circuit 1102 is a parallel data processing circuit with a highly parallel data microarchitecture, such as a GPU. The processing circuit 1102 can be a discrete device, such as a dedicated GPU (dGPU), or the processing circuit 1102 can be integrated (an iGPU) in the same package as another processing circuit. Other parallel data processing circuits that can be included in computing system 1100 include digital signal processing circuits (DSPs), field programmable gate arrays (FPGAs), application specific integrated circuits (ASICs), and so forth.

In various implementations, the processing circuit 1102 includes multiple, replicated compute circuits 1104A-1104N, each including similar circuitry and components such as the SIMD circuits 1108A-1108B, the cache 1107, and hardware resources (not shown). The SIMD circuit 1108A includes replicated circuitry of the circuitry of the SIMD circuit 1108A. Although two SIMD circuits are shown, in other implementations, another number of SIMD circuits is used based on design requirements. As shown, the SIMD circuit 1108B includes multiple, parallel computational lanes 1106. The cache 1107 can be used as a shared last-level cache in a compute circuit similar to the cache 370 (of FIG. 3) and the cache 452 (of FIG. 4).

The hardware of the scheduler 1105 assigns wavefronts to be dispatched to the compute circuits 1104A-1104N. In an implementation, scheduler 1105 is a command processing circuit of a GPU. In some implementations, the application 1146 stored on the memory devices 1140 and its copy (application 1116) stored on the memory 1112 are a highly parallel data application that includes particular function calls using an API to allow the developer to insert a request in the highly parallel data application for launching wavefronts of a kernel (function call). In an implementation, this kernel launch request is a C++ object, and it is converted by circuitry 1118 of the processing circuit 1110 to a command. In one implementation, the command is a kernel dispatch Architected Queueing Language (AQL) packet. The command is inserted in one of multiple queues of the processing circuit 1102 that executes the commands. The scheduler 1105 assigns the command that launches a kernel to one of the compute circuits 1104A-1104N. In addition, a developer defines cohorts in application 1146. For example, a developer inserts a barrier packet in the highly parallel data application by using the application programming interface (API).

In some implementations, application 1146 is one example of an application that utilizes complex directed acyclic graphs (DAGs). Complex DAGs associated with many applications can be decomposed into fine-grain tasks that share a working data set such as cohort data. Some applications perform a sparse tensor decomposition, which is used for extracting unknown patterns from sparse and multivariate datasets in machine learning, data analytics, recommender systems, graph analysis, computer vision, and so forth. Typically, sparse tensor decomposition is computed using the Canonical Decomposition/Parallel Factors-Alternating Least Squares (CP-ALS) approach. Traditionally, CP-ALS iteratively performs large Matricized Tensor Times Khatri-Rao product (MTTKRP) and general matrix-matrix multiplication (GEMM) operations. These large-scale MTTKRPs and GEMMs operations can be divided into smaller operations that share cache-sized chunks of input data. Scheduling these operations for execution together on the hardware (spatially and/or temporally), such as the multiple compute circuits 1104A-1104N, would increase performance by improving data reuse within cache 1107.

In various implementations, the scheduler 1105 has the same functionality as the scheduler 114 (of FIG. 1), the scheduler 340 (of FIG. 3), and the command processing circuit 435 (of FIG. 4). For example, the scheduler 1105 balances high throughput and low cache contention. To do so, scheduler 1105 determines whether a dispatch rate condition is satisfied. The scheduler 1105 determines that the dispatch rate condition is satisfied when a first duration is greater than a second duration. To determine the first duration and the second duration, in some implementations, the scheduler 1105 performs steps described in an earlier example for the command processing circuit 435 (of FIG. 4). For example, the first duration indicates the amount of time for kernels of each currently executing cohort that are already scheduled for execution to complete with input data stored in a cache. The second duration indicates the amount of time for kernels of a next pending cohort not yet scheduled for execution to complete without input data stored in the cache. If the first duration is not greater than the second duration, then the scheduler schedules the next pending cohort for dispatch and execution. However, if the first duration is greater than the second duration, then the scheduler delays scheduling the next pending cohort for dispatch and execution.

The high parallelism offered by the hardware of the compute circuits 1104A-1104N is used for real-time data processing. Examples of real-time data processing are rendering multiple pixels, image blending, pixel shading, vertex shading, and geometry shading. In such cases, each of the data items of a wavefront is a pixel of an image. The compute circuits 1104A-1104N can also be used to execute other threads that require operating simultaneously with a relatively high number of different data elements (or data items). Examples of these threads are threads for scientific, medical, finance and encryption/decryption computations.

Memory 1112 represents a local hierarchical cache memory subsystem. Memory 1112 stores source data, intermediate results data, results data, and copies of data and instructions stored in memory devices 1140. Processing circuit 1110 is coupled to bus 1125 via interface 1109. Processing circuit 1110 receives, via interface 1109, copies of various data and instructions, such as the operating system 1142, one or more device drivers, one or more applications such as application 1146, and/or other data and instructions. The processing circuit 1110 retrieves a copy of the application 1144 from the memory devices 1140, and the processing circuit 1110 stores this copy as application 1116 in memory 1112.

In some implementations, computing system 1100 utilizes a communication fabric (“fabric”), rather than the bus 1125, for transferring requests, responses, and messages between the processing circuits 1102 and 1110, the I/O interfaces 1120, the memory controllers 1130, the network interface 1135, and the display controller 1150. When messages include requests for obtaining targeted data, the circuitry of interfaces within the components of computing system 1100 translates target addresses of requested data. In some implementations, the bus 1125, or a fabric, includes circuitry for supporting communication, data transmission, network protocols, address formats, interface signals and synchronous/asynchronous clock domain usage for routing data.

Memory controllers 1130 are representative of any number and type of memory controllers accessible by processing circuits 1102 and 1110. While memory controllers 1130 are shown as being separate from processing circuits 1102 and 1110, it should be understood that this merely represents one possible implementation. In other implementations, one of memory controllers 1130 is embedded within one or more of processing circuits 1102 and 1110 or it is located on the same semiconductor die as one or more of processing circuits 1102 and 1110. Memory controllers 1130 are coupled to any number and type of memory devices 1140.

Memory devices 1140 are representative of any number and type of memory devices. For example, the type of memory in memory devices 1140 includes Dynamic Random Access Memory (DRAM), Static Random Access Memory (SRAM), NAND Flash memory, NOR flash memory, Ferroelectric Random Access Memory (FeRAM), or otherwise. Memory devices 1140 store at least instructions of an operating system 1142, one or more device drivers, and application 1144. In some implementations, application 1144 is a highly parallel data application such as a video graphics application, a shader application, or other. Copies of these instructions can be stored in a memory or cache device local to processing circuit 1110 and/or processing circuit 1102.

I/O interfaces 1120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 1120. Such peripheral devices include (but are not limited to) displays, keyboards, mice, printers, scanners, joysticks or other types of game controllers, media recording devices, external storage devices, and so forth. Network interface 135 receives and sends network messages across a network.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An integrated circuit comprising:
a plurality of compute circuits; and
a scheduler comprising circuitry configured to:
create a plurality of scheduling groups including at least a first scheduling group that accesses a first data set and a second scheduling group that accesses a second data set different from the first data set, each of the scheduling groups comprising kernels of a plurality of kernels;
execute the first scheduling group on one or more of the plurality of compute circuits;
execute the second scheduling group on available hardware resources of the plurality of compute circuits, based at least in part on a dispatch rate not being satisfied; and
delay execution of the second scheduling group on the available hardware resources of the plurality of compute circuits, based at least in part on the dispatch rate condition being satisfied.

2. The integrated circuit as recited in claim 1, wherein the dispatch rate condition being satisfied comprises a duration of execution of the first scheduling group is greater than a duration of execution of the second scheduling group.

3. The integrated circuit as recited in claim 2, wherein the scheduler is further configured to schedule execution of a third scheduling group of the plurality of scheduling groups that accesses a third data set, based at least in part on a dispatch rate condition for the third scheduling group not being satisfied.

4. The integrated circuit as recited in claim 2, wherein the scheduler is further configured to generate the first duration based on the first data set being stored in a cache.

5. The integrated circuit as recited in claim 4, wherein the scheduler is further configured to generate the first duration based on a difference between a completion time estimate of the first scheduling group with the first data set stored in the cache and an amount of time that has elapsed since the first scheduling group had begun execution.

6. The integrated circuit as recited in claim 4, wherein the scheduler is further configured to generate the second duration based on a corresponding data set accessed by the given scheduling group being not initially stored in the cache.

7. The integrated circuit as recited in claim 6, wherein the scheduler is further configured to generate the second duration based on a number of available single instruction multiple data (SIMD) circuits of the plurality of compute circuits.

8. A method comprising:
creating, by circuitry of a scheduler, a plurality of scheduling groups including at least a first scheduling group that accesses a first data set and a second scheduling group that accesses a second data set different from the first data set, each of the scheduling groups comprising kernels of a plurality of kernels;
executing the first scheduling group on one or more of the plurality of compute circuits; and
delaying execution, by the circuitry, of the second scheduling group on available hardware resources of the plurality of compute circuits, based at least in part on a dispatch rate condition for the second scheduling group being satisfied.

9. The method as recited in claim 8, wherein the dispatch rate condition being satisfied comprises a duration of execution of the first scheduling group is greater than a duration of execution of the second scheduling group.

10. The method as recited in claim 9, further comprising scheduling execution, by the circuitry on available hardware resources of the plurality of compute circuits, of a third scheduling group of the plurality of scheduling groups that accesses a third data set, based at least in part on a dispatch rate condition for the third scheduling group not being satisfied.

11. The method as recited in claim 9, further comprising generating, by the circuitry, the first duration based on the first data set being stored in a cache.

12. The method as recited in claim 11, further comprising generating, by the circuitry, the first duration based on a difference between a completion time estimate of the first scheduling group with the first data set stored in the cache and an amount of time that has elapsed since the first scheduling group had begun execution.

13. The method as recited in claim 11, further comprising generating, by the circuitry, the second duration based on a corresponding data set accessed by the given scheduling group being not initially stored in the cache.

14. The method as recited in claim 13, further comprising generating, by the circuitry, the second duration based on a number of available single instruction multiple data (SIMD) circuits of the plurality of compute circuits.

15. A computing system comprising:
a cache configured to store a copy of data stored in a memory;
a processing circuit comprising:
a plurality of chiplets; and
a scheduler comprising circuitry configured to:
create a plurality of scheduling groups including at least a first scheduling group that accesses a first data set and a second scheduling group that accesses a second data set different from the first data set, each of the scheduling groups comprising kernels of a plurality of kernels;
execute the first scheduling group on one or more of the plurality of chiplets; and
delay execution of the second scheduling group on available hardware resources of the plurality of chiplets, based at least in part on a dispatch rate condition for the second scheduling group being satisfied.

16. The computing system as recited in claim 15, wherein the dispatch rate condition being satisfied comprises a duration of execution of the first scheduling group is greater than a duration of execution of the second scheduling group.

17. The computing system as recited in claim 16, wherein the scheduler is further configured to schedule execution, on available hardware resources of the plurality of chiplets, of a third scheduling group of the plurality of scheduling groups that accesses a third data set, based at least in part on a dispatch rate condition for the third scheduling group not being satisfied.

18. The computing system as recited in claim 16, wherein the scheduler is further configured to generate the first duration based on the first data set being stored in a cache.

19. The computing system as recited in claim 18, wherein the scheduler is further configured to generate the first duration based on a difference between a completion time estimate of the first scheduling group with the first data set stored in the cache and an amount of time that has elapsed since the first scheduling group had begun execution.

20. The computing system as recited in claim 18, wherein the scheduler is further configured to generate the second duration based on a corresponding data set accessed by the given scheduling group being not initially stored in the cache.
